(19) United States
(12) Patent Application Publication
(10) Pub. No.: US 2022/0383646 A1
(43) Pub. Date: Dec. 1, 2022

(54) MOBILE OBJECT CONTROL DEVICE, MOBILE OBJECT CONTROL METHOD, AND STORAGE MEDIUM

(71) Applicant: HONDA MOTOR CO., LTD., Tokyo (JP)

(72) Inventors: Tomoyuki Hosoya, Wako-shi (JP); Takao Tamura, Wako-shi (JP)

(21) Appl. No.: 17/748,080

(22) Filed: May 19, 2022

(30) Foreign Application Priority Data
May 27, 2021 (JP) 2021-089427

(51) Int. Cl. G06V 20/56; G06V 10/44; G06T 7/13; G06T 7/70; B60W 30/12; B60W 40/06

(52) U.S. Cl. CPC G06V 20/588; G06V 10/443; G06T 7/13; G06T 7/70; B60W 30/12; B60W 40/06; G06T 2207/30256; B60W 2420/42; B60W 2552/53; B60W 2556/25; B60W 2556/40

(57) ABSTRACT

According to an embodiment, a mobile object control device includes a recognizer configured to recognize a surrounding situation of a mobile object on the basis of an output of an external sensor and a marking recognizer configured to recognize markings for dividing an area through which the mobile object passes on the basis of the surrounding situation recognized by the recognizer. The marking recognizer extracts a prescribed area from the surrounding situation when it is determined that marking recognition accuracy has been lowered, extracts an edge within the extracted prescribed area, and recognizes the markings on the basis of an extraction result.

### CROSS-REFERENCE TO RELATED APPLICATION

Priority is claimed on Japanese Patent Application No. 2021-089427, filed May 27, 2021, the content of which is incorporated herein by reference.

### BACKGROUND

### Field of the Invention

The present invention relates to a mobile object control device, a mobile object control method, and a storage medium.

### Description of Related Art

In recent years, research on automated driving that automatically controls the traveling of a vehicle has been conducted. In this regard, technology for estimating virtual markings on the basis of positions of previously detected markings when the present state changes from a state in which markings of a lane in which vehicles are traveling are detected to a state in which no markings are detected and controlling traveling of a host vehicle so that the host vehicle is at a prescribed position with respect to the estimated virtual markings is known (for example, PCT International Publication No. WO 2018/012179).

### SUMMARY

However, because positions of previously detected markings do not always continue as they are, there is a case where markings different from the actual ones are recognized.

Aspects of the present invention have been made in consideration of such circumstances and the present invention provides a mobile object control device, a mobile object control method, and a storage medium capable of further improving the accuracy of recognition of markings for dividing an area through which a mobile object passes.

A mobile object control device, a mobile object control method, and a storage medium according to the present invention adopt the following configurations.

(1): According to an aspect of the present invention, there is provided a mobile object control device including: a recognizer configured to recognize a surrounding situation of a mobile object on the basis of an output of an external sensor; and a marking recognizer configured to recognize markings for dividing an area through which the mobile object passes on the basis of the surrounding situation recognized by the recognizer, wherein the marking recognizer extracts a prescribed area from the surrounding situation when it is determined that marking recognition accuracy has been lowered, extracts an edge within the extracted prescribed area, and recognizes the markings on the basis of an extraction result.

(2): In the above-described aspect (1), the mobile object control device further includes a storage controller configured to cause a storage to store information about the markings before the marking recognizer determines that the marking recognition accuracy has been lowered, wherein the marking recognizer extracts marking candidates on the basis of the edge extracted from the prescribed area and recognizes the markings for dividing the area through which the mobile object passes on the basis of degrees of similarity between information about the extracted marking candidates and the information about the markings stored in the storage.

(3): In the above-described aspect (2), the information about the markings includes at least one of positions, directions, and types of the markings.

(4): In the above-described aspect (2), the storage further stores map information and the marking recognizer extracts the prescribed area on the basis of information about the markings acquired from the map information on the basis of position information of the mobile object or the information about the markings before it is determined that the marking recognition accuracy has been lowered stored in the storage when it is determined that the marking recognition accuracy has been lowered.

(5): In the above-described aspect (1), the prescribed area is set on left and right sides in a traveling direction of the mobile object.

(6): In the above-described aspect (1), the marking recognizer extracts the edge in the surrounding situation and determines that the marking recognition accuracy has been lowered when at least one of a length, reliability, and quality of the extracted edge is less than a threshold value.

(7): According to an aspect of the present invention, there is provided a mobile object control method including: recognizing, by a computer, a surrounding situation of a mobile object on the basis of an output of an external sensor; recognizing, by the computer, markings for dividing an area through which the mobile object passes on the basis of the recognized surrounding situation; extracting, by the computer, a prescribed area from the surrounding situation when it is determined that marking recognition accuracy has been lowered; extracting, by the computer, an edge within the extracted prescribed area; and recognizing, by the computer, the markings on the basis of an extraction result.

(8): According to an aspect of the present invention, there is provided a computer-readable non-transitory storage medium storing a program for causing a computer to: recognize a surrounding situation of a mobile object on the basis of an output of an external sensor; recognize markings for dividing an area through which the mobile object passes on the basis of the recognized surrounding situation; extract a prescribed area from the surrounding situation when it is determined that marking recognition accuracy has been lowered; extract an edge within the extracted prescribed area; and recognize the markings on the basis of an extraction result.

According to the above-described aspects (1) to (8), it is possible to further improve the accuracy of recognition of markings for dividing an area through which a mobile object passes.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram for describing an example of marking recognition according to the embodiment.

FIG. 4 is a diagram for describing content of recognized marking information.

FIG. 5 is a diagram for describing the extraction of a prescribed area.

FIG. 6 is a diagram for describing an example of extraction of marking candidates.

FIG. 7 is a diagram for describing recognition of markings of a traveling lane from the marking candidates.

FIG. 8 is a flowchart showing an example of a flow of a process executed by an automated driving control device of the embodiment.

### DESCRIPTION OF EMBODIMENTS

Embodiments of a mobile object control device, a mobile object control method, and a storage medium of the present invention will be described below with reference to the drawings. Hereinafter, a vehicle is used as an example of a mobile object. The vehicle is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power when a secondary battery or a fuel cell is discharged. Hereinafter, an embodiment in which the mobile object control device is applied to an automated driving vehicle will be described as an example. For example, automated driving is a process of executing driving control by automatically controlling one or all of steering, acceleration, and deceleration of the vehicle. The driving control of the vehicle may include, for example, various types of driving assistance control such as adaptive cruise control (ACC), auto lane changing (ALC), a lane keeping assistance system (LKAS), and traffic jam pilot (TJP). Some or all driving of the automated driving vehicle may be controlled according to manual driving of an occupant (a driver). The mobile object may include, in addition to (or instead of) a vehicle, for example, a ship, a flying object (including, for example, a drone, an aircraft, etc.) and the like.

### [Overall Configuration]

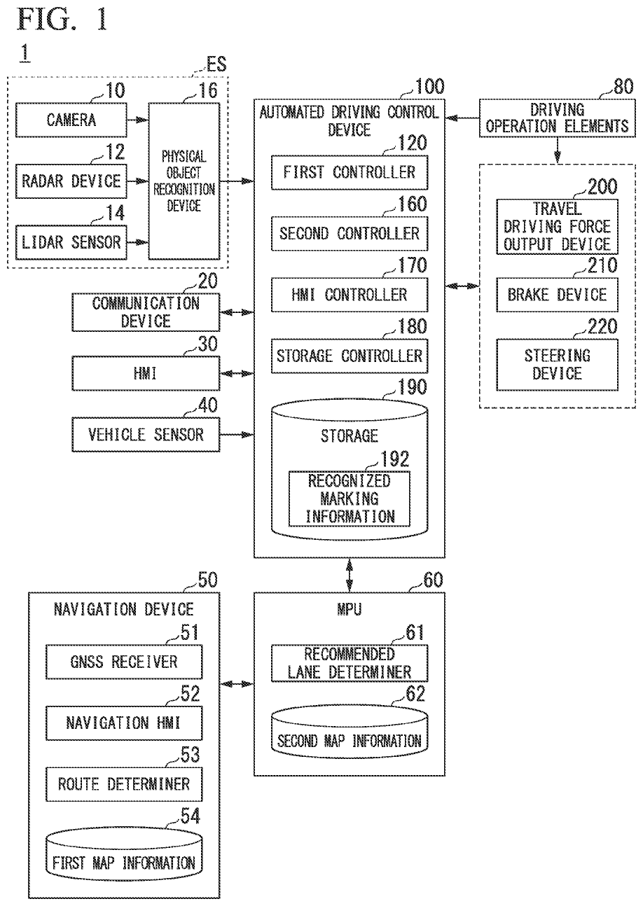

FIG. 1 is a configuration diagram of a vehicle system 1 using a vehicle control device according to an embodiment. For example, the vehicle system 1 includes a camera 10, a radar device 12, a light detection and ranging (LIDAR) sensor 14, a physical object recognition device 16, a communication device 20, a human machine interface (HMI) 30, a vehicle sensor 40, a navigation device 50, a map positioning unit (MPU) 60, driving operation elements 80, an automated driving control device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and some of the components may be omitted or other components may be further added. A combination of the camera 10, the radar device 12, the LIDAR sensor 14, and the physical object recognition device 16 is an example of an “external sensor.” An external sensor ES may include, for example, a sound navigation and ranging (SONAR) sensor (not shown). The HMI 30 is an example of an “output.” The automated driving control device 100 is an example of a “mobile object control device.”

For example, the camera 10 is a digital camera using a solid-state imaging element such as a charge coupled device (CCD) or a complementary metal oxide semiconductor (CMOS). The camera 10 is attached to any position on the vehicle (hereinafter, a vehicle M) in which the vehicle system 1 is mounted. When the view in front of the vehicle M is imaged, the camera 10 is attached to an upper part of a front windshield, a rear surface of a rearview mirror, or the like. For example, the camera 10 periodically and iteratively images the surroundings of the vehicle M. The camera 10 may be a stereo camera.

The radar device 12 radiates radio waves such as millimeter waves around the vehicle M and detects at least a position (a distance to and a direction) of a physical object by detecting radio waves (reflected waves) reflected by the physical object. The radar device 12 is attached to any position on the vehicle M. The radar device 12 may detect a position and a speed of the physical object in a frequency modulated continuous wave (FM-CW) scheme.

The LIDAR sensor 14 radiates light (or electromagnetic waves of a wavelength close to that of light) to the vicinity of the vehicle M and measures scattered light. The LIDAR sensor 14 detects a distance to an object on the basis of a time period from light emission to light reception. The radiated light is, for example, pulsed laser light. The LIDAR sensor 14 is attached to any position on the vehicle M. When the SONAR sensor is provided on the vehicle M, the SONAR sensor is provided, for example, on a front end and a rear end of the vehicle M, and is installed on a bumper or the like. The SONAR sensor detects a physical object (for example, an obstacle) within a prescribed distance from an installation position.

The physical object recognition device 16 performs a sensor fusion process on detection results from some or all of the components of the external sensor ES (the camera 10, the radar device 12, the LIDAR sensor 14, and the SONAR sensor) to recognize a position, a type, a speed, and the like of a physical object. The physical object recognition device 16 outputs recognition results to the automated driving control device 100. The physical object recognition device 16 may output detection results of the external sensor ES to the automated driving control device 100 as they are. In this case, the physical object recognition device 16 may be omitted from the vehicle system 1.

The communication device 20 communicates with another vehicle in the vicinity of the vehicle M using, for example, a cellular network, a Wi-Fi network, Bluetooth (registered trademark), dedicated short range communication (DSRC), or the like, or communicates with various types of server devices via a radio base station.

The HMI 30 outputs various types of information to the occupant of the vehicle M and receives input operations from the occupant. The HMI 30 includes, for example, various types of display devices, a speaker, a buzzer, a touch panel, a switch, a key, a microphone, and the like. The various types of display devices are, for example, a liquid crystal display (LCD), an organic electro luminescence (EL) display device, and the like. The display device is provided, for example, near the front of the driver's seat (the seat closest to a steering wheel) on an instrument panel, and is installed at a position where the occupant can perform visual recognition from the steering wheel gap or through the steering wheel. The display device may be installed at the center of the instrument panel. The display device may be a head up display (HUD). The HUD projects an image onto a part of the front windshield in front of the driver's seat so that the eyes of the occupant sitting in the driver's seat can see the virtual image. The display device displays an image generated by the HMI controller 170 to be described below. The HMI 30 may include an operation changeover switch or the like that mutually switches between automated driving and manual driving by the occupant.

The vehicle sensor 40 includes a vehicle speed sensor configured to detect the speed of the vehicle M, an acceleration sensor configured to detect acceleration, a yaw rate sensor configured to detect an angular speed around a vertical axis, a direction sensor configured to detect a direction of the vehicle M, and the like. The vehicle sensor 40 may include a position sensor that acquires a position of the vehicle M. The position sensor is, for example, a sensor that acquires position information (longitude/latitude information) from a Global Positioning System (GPS) device. The position sensor may be a sensor that acquires position information using a global navigation satellite system (GNSS) receiver 51 of the navigation device 50.

For example, the navigation device 50 includes the GNSS receiver 51, a navigation HMI 52, and a route determiner 53. The navigation device 50 retains first map information 54 in a storage device such as a hard disk drive (HDD) or a flash memory. The GNSS receiver 51 identifies a position of the vehicle M on the basis of a signal received from a GNSS satellite. The position of the vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route determiner 53 determines a route (hereinafter referred to as a route on a map) from the position of the vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include curvature of a road, point of interest (POI) information, and the like. The route on the map is output to the MPU 60. The navigation device 50 may perform route guidance using the navigation HMI 52 on the basis of the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

For example, the MPU 60 includes a recommended lane determiner 61 and retains second map information 62 in a storage device such as an HDD or a flash memory. The recommended lane determiner 61 divides the route on the map provided from the navigation device 50 into a plurality of blocks (for example, divides the route every 100 [m] in a traveling direction of the vehicle), and determines a recommended lane for each block with reference to the second map information 62. The recommended lane determiner 61 determines in what lane numbered from the left the vehicle will travel. For example, the recommended lane determiner 61 determines the recommended lane so that the vehicle M can travel along a reasonable route for traveling to a branching destination when there is a branch point in the route on the map.

The second map information 62 is map information which has higher accuracy than the first map information 54. The second map information 62 includes, for example, road marking information such as positions, directions, and types of road markings (hereinafter simply referred to as “markings”) that divide one or more lanes included in a road, information of the center of the lane or information of the boundary of the lane based on the marking information, and the like. The second map information 62 may include information about protective barriers such as guardrails and fences, chatter bars, curbs, median strips, road shoulders, sidewalks, and the like provided along an extension direction of the road or the like. The second map information 62 may include road information (a type of road), legal speeds (a speed limit, a maximum speed, and a minimum speed), traffic regulation information, address information (an address/postal code), facility information, telephone number information, and the like. The second map information 62 may be updated at any time when the communication device 20 communicates with another device.

The driving operation elements 80 include, for example, an accelerator pedal, a brake pedal, a shift lever, and other operation elements in addition to the steering wheel. A sensor for detecting an amount of operation or the presence or absence of an operation is attached to the driving operation element 80 and a detection result is output to the automated driving control device 100 or some or all of the travel driving force output device 200, the brake device 210, and the steering device 220. The operation element does not necessarily have to be annular and may be in the form of a variant steering wheel, a joystick, a button, or the like.

The automated driving control device 100 includes, for example, a first controller 120, a second controller 160, an HMI controller 170, a storage controller 180, and a storage 190. Each of the first controller 120, the second controller 160, and the HMI controller 170 is implemented, for example, by a hardware processor such as a central processing unit (CPU) executing a program (software). Some or all of the above components may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be prestored in a storage device (a storage device including a non-transitory storage medium) such as an HDD or a flash memory of the automated driving control device 100 or may be stored in a removable storage medium such as a DVD or a CD-ROM and installed in the HDD or the flash memory of the automated driving control device 100 when the storage medium (the non-transitory storage medium) is mounted in a drive device. A combination of the action plan generator 140 and the second controller 160 is an example of a “driving controller.” The HMI controller 170 is an example of an “output controller.”

The storage 190 may be implemented by the above-described various types of storage devices or a solid-state drive (SSD), an electrically erasable programmable read-only memory (EEPROM), a read-only memory (ROM), a random-access memory (RAM), or the like. The storage 190 stores, for example, recognized marking information 192, a program, various other types of information, and the like. Details of the recognized marking information 192 will be described below. The above-described map information (first map information 54 and second map information 62) may be stored in the storage 190.

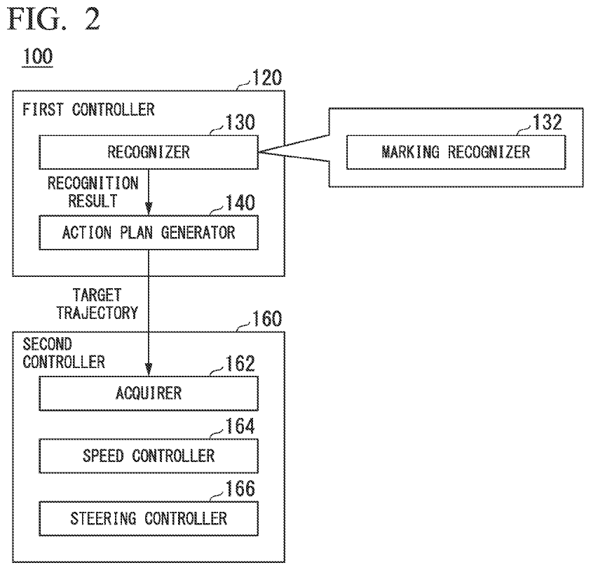

FIG. 2 is a functional configuration diagram of the first controller 120 and the second controller 160. The first controller 120 includes, for example, a recognizer 130 and the action plan generator 140. For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals, road signs, or the like with which pattern matching is possible) in parallel and performing comprehensive evaluation by assigning scores to both recognition processes. Thereby, the reliability of automated driving is secured.

The recognizer 130 recognizes space information indicating a surrounding situation of the vehicle M, for example, on the basis of information input from the external sensor ES. For example, the recognizer 130 recognizes states of positions, speeds, acceleration, and the like of physical objects (for example, other vehicles or other obstacles) near the vehicle M. For example, the position of the physical object is recognized as a position on absolute coordinates with a representative point (a center of gravity, a driving shaft center, or the like) of the vehicle M as the origin and is used for control. The position of the physical object may be represented by a representative point such as a center of gravity or a corner of the physical object or may be represented by an area. The “state” of a physical object may include acceleration or jerk of another vehicle or an “action state” (for example, whether or not a lane change is being made or intended) when the physical object is a mobile object such as another vehicle.

The recognizer 130 recognizes, for example, a lane where the vehicle M is traveling (a traveling lane) from a surrounding situation of the vehicle M. The lane recognition is executed by the marking recognizer 132 provided in the recognizer 130. The details of the function of the marking recognizer 132 will be described below. The recognizer 130 recognizes an adjacent lane adjacent to the traveling lane. The adjacent lane is, for example, a lane where the vehicle M can travel in the same direction as the traveling lane. The recognizer 130 recognizes a temporary stop line, an obstacle, red traffic light, a toll gate, a road sign, and other road events.

When the traveling lane is recognized, the recognizer 130 recognizes a position or an orientation of the vehicle M with respect to the traveling lane. For example, the recognizer 130 may recognize a gap of a reference point of the vehicle M from the center of the lane and an angle formed with respect to a line connected to the center of the lane in a traveling direction of the vehicle M as a relative position and an orientation of the vehicle M related to the traveling lane. Alternatively, the recognizer 130 may recognize a position of the reference point of the vehicle M related to one side end (a marking or a road boundary) of the traveling lane or the like as a relative position of the vehicle M related to the traveling lane. Here, the reference point of the vehicle M may be the center of the vehicle M or the center of gravity. The reference point may be an end (a front end or a rear end) of the vehicle M or may be a position where one of a plurality of wheels provided in the vehicle M is present.

The action plan generator 140 generates a future target trajectory along which the vehicle M automatedly travels (independently of the driver's operation) so that the vehicle M can generally travel in the recommended lane determined by the recommended lane determiner 61 and cope with a surrounding situation of the vehicle M. For example, the target trajectory includes a speed element. For example, the target trajectory is represented by sequentially arranging points (trajectory points) at which the vehicle M is required to arrive. The trajectory points are points at which the vehicle M is required to arrive for each prescribed traveling distance (for example, about several meters [m]) along a road. In addition, a target speed and target acceleration for each prescribed sampling time (for example, about several tenths of a second [sec]) are generated as parts of the target trajectory. The trajectory point may be a position at which the vehicle M is required to arrive at the sampling time for each prescribed sampling time. In this case, information about the target speed or the target acceleration is represented by an interval between the trajectory points.

The action plan generator 140 may set an automated driving event (function) when a target trajectory is generated. Automated driving events include a constant-speed traveling event, a low-speed tracking event, a lane change event, a branch point-related movement event, a merge point-related movement event, a takeover event, and the like. The action plan generator 140 generates a target trajectory according to an activated event.

The second controller 160 controls the travel driving force output device 200, the brake device 210, and the steering device 220 so that the vehicle M passes along the target trajectory generated by the action plan generator 140 at the scheduled times.

The second controller 160 includes, for example, an acquirer 162, a speed controller 164, and a steering controller 166. The acquirer 162 acquires information of a target trajectory (trajectory points) generated by the action plan generator 140 and causes a memory (not shown) to store the information. The speed controller 164 controls the travel driving force output device 200 or the brake device 210 on the basis of a speed element associated with the target trajectory stored in the memory. The steering controller 166 controls the steering device 220 in accordance with a degree of curvature of the target trajectory stored in the memory. The processes of the speed controller 164 and the steering controller 166 are implemented by, for example, a combination of feedforward control and feedback control. As an example, the steering controller 166 executes feedforward control according to the curvature of the road in front of the vehicle M and feedback control based on a deviation from the target trajectory in combination.

The HMI controller 170 notifies the driver of the vehicle M of prescribed information using the HMI 30. The prescribed information includes, for example, driving assistance information. The driving assistance information includes, for example, information such as a speed of the vehicle M, an engine speed, the remaining amount of fuel, a radiator water temperature, a traveling distance, a state of a shift lever, a marking, a lane, other vehicles, and the like recognized by the physical object recognition device 16, the automated driving control device 100, and the like, a lane in which the vehicle M should travel, and a future target trajectory. The driving assistance information may include information indicating the switching of the driving mode to be described below and a driving state (for example, a type of automated driving in operation such as LKAS or ALC) in the driving assistance process and the like. For example, the HMI controller 170 may generate an image including the above-described prescribed information, cause the display device of the HMI 30 to display the generated image, generate a sound indicating the prescribed information, and cause the generated sound to be output from the speaker of the HMI 30. The HMI controller 170 may output the information received by the HMI 30 to the communication device 20, the navigation device 50, the first controller 120, and the like.

The travel driving force output device 200 outputs a travel driving force (torque) for enabling the vehicle M to travel to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described components in accordance with information input from the second controller 160 or information input from the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the driving operation element 80 so that brake torque according to a braking operation is output to each wheel. The brake device 210 may include a mechanism configured to transfer the hydraulic pressure generated according to an operation on the brake pedal included in the driving operation elements 80 to the cylinder via a master cylinder as a backup. The brake device 210 is not limited to the above-described configuration and may be an electronically controlled hydraulic brake device configured to control an actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the second controller 160 or the information input from the steering wheel 82 of the driving operation element 80 to change the direction of the steerable wheels.

### [Regarding Marking Recognition]

Hereinafter, a marking recognition process according to the embodiment will be described. Hereinafter, a scene in which LKAS control based on automated driving is executed will be described. The LKAS control is, for example, a control process of controlling the steering of the vehicle M so that the vehicle M travels near the center of the traveling lane while recognizing the markings of the traveling lane, and supporting lane keeping of the vehicle M.

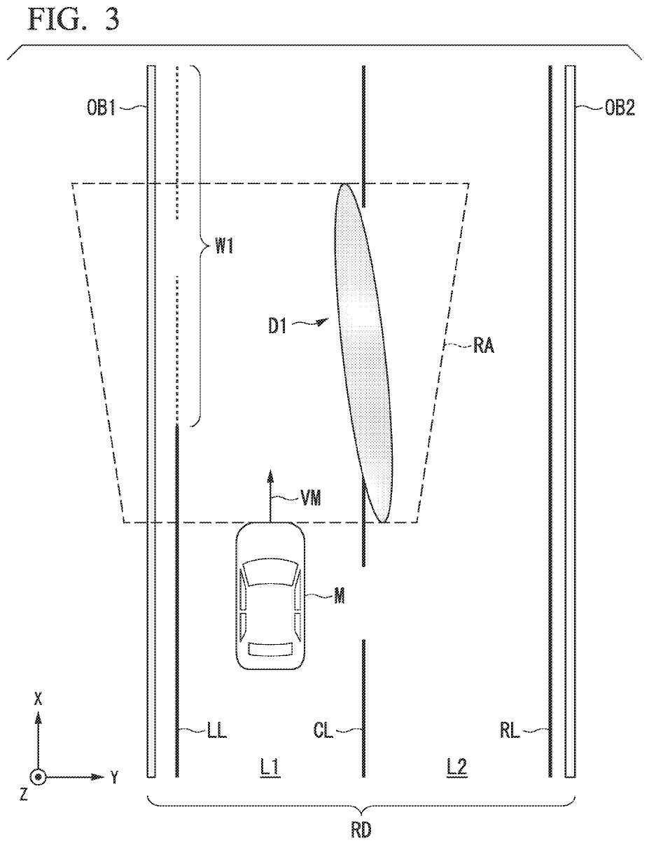

FIG. 3 is a diagram for describing an example of marking recognition according to the embodiment. In the example of FIG. 3, a road RD including two lanes L1 and L2 where the vehicle M can travel in the same direction (an X-axis direction in FIG. 3) and the vehicle M that is traveling in the lane L1 along an extension direction (the X-axis direction) of the road RD at a speed VM are shown. It is assumed that the lane L1 is a passage area of the vehicle M partitioned by markings LL and CL. The lane L2 is an area partitioned by markings CL and RL and is a lane adjacent to the lane L1. In the example of FIG. 3, it is assumed that physical objects (road structures) OB1 and OB2 such as guardrails are provided at both side ends of the road RD (outside of the markings LL and RL when viewed from the center of the road RD). The physical object OB1 is installed along the extension direction of the marking LL and the physical object OB2 is installed along the extension direction of the marking RL. In the example of FIG. 3, a range (hereinafter, a recognizable range) RA in which the physical object can be recognized by the external sensor ES is shown. Although the recognizable range RA shown in FIG. 3 indicates an area in a forward direction of the vehicle M for convenience of description, both a side direction and a rear direction of the vehicle M may be included therein. The recognizable range RA differs according to, for example, the performance of the external sensor ES and the like.

The marking recognizer 132 recognizes markings of the lane L1 in which the vehicle M travels, for example, on the basis of space information indicating a surrounding situation within the recognizable range RA of the external sensor ES. The recognition of the markings is repeatedly executed at prescribed timings. The prescribed timings may be, for example, prescribed cycle times or timings based on a speed or a traveling distance of the vehicle M.

For example, the marking recognizer 132 extracts an edge from a captured image of the recognizable range RA photographed by the camera 10 and recognizes a position of a marking on the basis of an extraction result. The edge includes, for example, a pixel (or a pixel group) in which a pixel value difference from pixels around the edge is larger than a reference value, i.e., a characteristic pixel. The marking recognizer 132 extracts the edge using, for example, a prescribed differential filter or an edge extraction filter such as a Prewitt filter or a Sobel filter with respect to a luminance value of each pixel within the image. The above-described edge extraction filter is merely an example, and the marking recognizer 132 may extract an edge on the basis of another filter or algorithm.

When there is a line segment (for example, a straight line or a curve) of an edge having a length longer than or equal to a first threshold value, the marking recognizer 132 recognizes the line segment as a marking on the basis of an edge extraction result. The marking recognizer 132 may connect edge line segments whose positions and directions are similar. The term “similar” indicates that a difference in a position or direction of the edge is within a prescribed range. The term “similar” may indicate that a degree of similarity is greater than or equal to a prescribed value.

The marking recognizer 132 may recognize that the line segment is a curve even if the line segment is greater than or equal to a first threshold value and the line segment is not a marking when the curvature thereof is greater than or equal to a prescribed value (a radius of curvature is less than or equal to a prescribed value). Thereby, a line segment that is clearly not a marking can be excluded and the accuracy of recognition of the marking can be improved.

The marking recognizer 132 may derive one or both of the reliability and quality of the edge in addition to (or instead of) the length of the edge. For example, the marking recognizer 132 derives the reliability of the edge as a marking in accordance with a degree of continuity and a degree of scattering of the extracted edge. For example, the marking recognizer 132 increases the reliability as the continuity of the line segment of the edge increases or the scattering in the extension direction of the edge decreases. The marking recognizer 132 may compare edges extracted from the left and right sides with respect to the position of the vehicle M and increase the reliability of the marking of each edge as a degree of similarity of the continuity or the scattering of the edge increases. The marking recognizer 132 increases the quality of the marking obtained from the edge as the number of extracted edges increases. For example, the quality may be replaced with an index value (a quality value) so that the value increases as the quality increases.

The marking recognizer 132 determines whether or not the marking recognition accuracy has been lowered. For example, the marking recognition accuracy is lowered when the actual marking is scratched, dirty, or the like or lowered by road surface reflection due to light from outside in the vicinity of the exit of a tunnel, road surface reflection due to outdoor lights in rainy weather or lights of an oncoming lane, performance deterioration of the external sensor ES due to the weather such as heavy rain, or the like. For example, when the length of the line segment of the edge extracted in an edge extraction process is less than the first threshold value, the marking recognizer 132 determines that the marking recognition accuracy has been lowered.

When the reliability or the quality value of the edge is derived, the marking recognizer 132 may determine that the marking recognition accuracy has been lowered if the reliability is less than a second threshold value or if the quality value is less than a third threshold value. That is, the marking recognizer 132 may determine that the marking recognition accuracy has been lowered, for example, when at least one of the length, reliability, and quality of the edge is less than the threshold value on the basis of results of the edge extraction process. Thereby, it is possible to more accurately determine whether or not the marking recognition accuracy has been lowered using a plurality of conditions. The marking recognizer 132 may determine whether the marking has been recognized normally using a criterion similar to the above-described determination criterion instead of determining whether or not the marking recognition accuracy has been lowered.

When the marking recognizer 132 determines that the marking recognition accuracy has not been lowered, the storage controller 180 stores the marking recognition result of the marking recognizer 132 (information about the marking) in recognized marking information 192. The information about the marking includes, for example, information about a state of the marking.

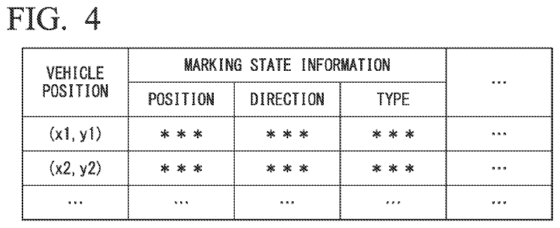

FIG. 4 is a diagram for describing content of the recognized marking information 192. The recognized marking information 192 is, for example, information in which recognized marking state information is associated with a vehicle position. The vehicle position is position information of the vehicle M acquired from the vehicle sensor 40. The marking state information includes, for example, a position, a direction, and a type of the recognized marking. The position is, for example, the position of the marking with respect to the recognized position of the vehicle M. The direction is, for example, an extension direction of the marking with respect to the position of the vehicle M. The type of marking or the like is included. The type is, for example, a line type (a solid line or a broken line), a width, and a color of the marking. The type may include, for example, the presence/absence of a chatter bar, the presence/absence of a median strip, and the like. When markings on the left and right sides of the vehicle M are recognized, the storage controller 180 stores the positions, directions, and types of both markings. The storage controller 180 may store the above-described information about the length, reliability, and quality of the edge in the recognized marking information 192. The storage controller 180 stores, for example, information about a marking for a short period (for example, from about several seconds to several minutes) before it is determined that the marking recognition accuracy has been lowered in the recognized marking information 192. Thereby, an amount of data can be reduced as compared with that when data is stored for a long period of time.

When it is determined that the marking recognition accuracy has been lowered, the marking recognizer 132 extracts a prescribed area from a surrounding situation recognized by the recognizer 130, extracts an edge with respect to the extracted prescribed area, and recognizes a marking of the lane L1 in which the vehicle M is traveling on the basis of an extraction result. In the scene of FIG. 3, scratches W1 of the marking LL or dirt D1 on the marking CL are present within the recognizable range RA. Therefore, the marking recognizer 132 determines that the accuracy of recognition of the markings LL and CL of the lane L1 in which the vehicle M is traveling has been lowered. In this case, the marking recognizer 132 first extracts the prescribed area from the surrounding situation.

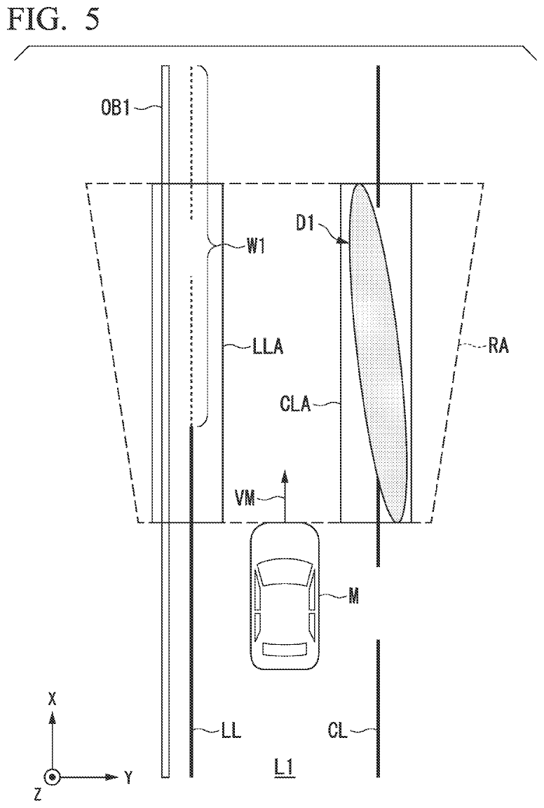

FIG. 5 is a diagram for describing the extraction of a prescribed area. In the example of FIG. 5, for convenience of description, an area of the lane L1 in which the host vehicle M mainly travels is shown schematically in the road RD shown in FIG. 3. The marking recognizer 132 extracts a marking presence area estimated to have a high likelihood of presence of a marking (a probability of presence thereof greater than or equal to a prescribed value) as an example of the prescribed area within the recognizable range RA of the external sensor ES of the vehicle M. For example, the marking recognizer 132 extracts the marking presence area on the basis of a position of the marking before the marking accuracy is lowered. For example, the marking recognizer 132 extracts a position and a direction of the marking state information associated with the vehicle position included in a prescribed distance range from the position information of the vehicle M with reference to the vehicle position of the recognized marking information 192 stored in the storage 190 on the basis of position information of the vehicle M acquired from the vehicle sensor 40 and extracts the marking presence area on the basis of the extracted position and direction. For example, the marking recognizer 132 extracts the marking presence area on the basis of degrees of scattering of the extracted position and direction. The marking recognizer 132 may extract a marking presence area predicted to have a high likelihood of presence of a marking in the future from the displacement of the extracted position and direction.

The marking recognizer 132 may extract a road on which the vehicle M travels from the position information of the vehicle M with reference to the second map information 62 on the basis of, for example, the position information of the vehicle M, in place of (or in addition to) the recognized marking information 192 and extract an area (a marking presence area) where there is a marking that divides the traveling lane from marking information of the extracted road. The marking recognizer 132 may extract the final marking presence area on the basis of the marking presence area extracted from the recognized marking information 192 and the marking presence area extracted from the second map information 62.

The marking recognizer 132 sets, for example, marking presence areas on the left and right sides of the vehicle M with respect to a traveling direction (a forward direction) of the vehicle M. The marking recognizer 132 may set a size or a shape of the marking presence area according to a position of other vehicles in a nearby area, the presence/absence and shape of a physical object OB such as a guardrail, and the like. In the example of FIG. 5, two marking presence areas LLA and CLA on the left and right sides when viewed from the vehicle M are extracted within the recognizable range RA of the external sensor ES. The marking recognizer 132 may recognize the marking presence areas LLA and CLA having the same size and shape or having different sizes and shapes. For example, if the vehicle M was traveling on a curve road at an immediately previous time, the marking recognizer 132 differentiates a shape or a size in accordance with an immediately previous difference between curvatures (or radiuses of curvature) of the markings of the right and left side. Thereby, it is possible to set a more optimal marking presence area.

The marking recognizer 132 extracts, for example, edges with respect to areas that are the marking presence areas LLA and CLA included in an image captured by the camera 10. In this case, the marking recognizer 132 extracts edges on the basis of the various types of edge extraction filters described above and other filters or algorithms. The marking presence areas LLA and CLA have higher likelihoods of presence of the markings than the other areas of the recognizable range RA. Thus, the marking recognizer 132 extracts edges using a filter or an algorithm that extracts the edges more easily than an edge extraction process of the marking recognizer 132. Thereby, the edge can be extracted more reliably within the marking presence area.

The marking recognizer 132 extracts a line segment of an edge whose length is greater than or equal to a fourth threshold value included in the marking presence areas LLA and CLA as a marking candidate. The fourth threshold value may be the first threshold value or may be smaller than the first threshold value. By making the threshold value smaller than the first threshold value, more marking candidates can be extracted. The marking recognizer 132 may connect line segments of edges whose positions or directions are similar.

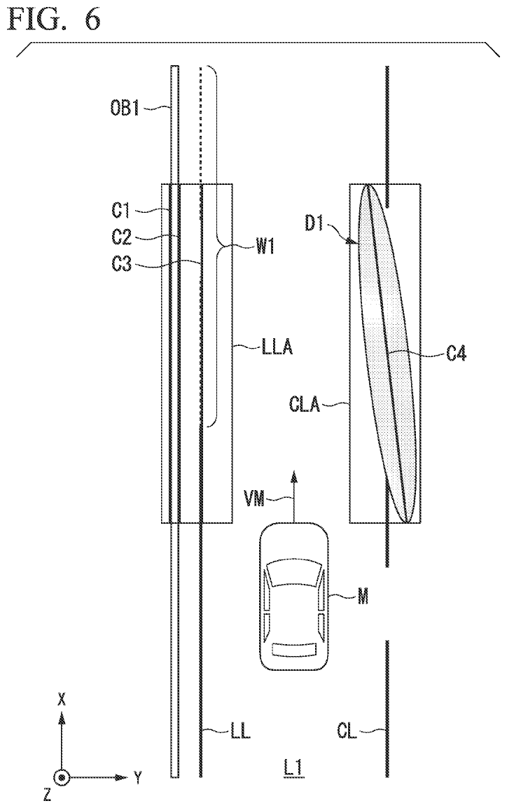

FIG. 6 is a diagram for describing an example in which marking candidates are extracted. In the example of FIG. 6, in an edge extraction process of the marking recognizer 132, three marking candidates C1 to C3 are extracted in the marking presence area LLA and one marking candidate C4 is extracted in the marking presence area CLA. The marking recognizer 132 derives marking candidate information of each of the extracted marking candidates C1 to C4. The marking candidate information includes information about the state of the marking candidate as information about the marking candidate. For example, the marking candidate information includes position information and an extension direction of each of the marking candidates C1 to C4 with respect to the position of the vehicle M. The marking candidate information may include information about a type of marking.

Next, the marking recognizer 132 acquires marking state information associated with the vehicle position closest to the position information (in other words, marking state information recognized finally in a state in which recognition accuracy has not been lowered in the marking recognition process) with reference to the vehicle position of the recognized marking information 192 using the position information of the vehicle M, compares the acquired marking state information with the marking candidate information, and recognizes a marking of the traveling lane from the marking candidates.

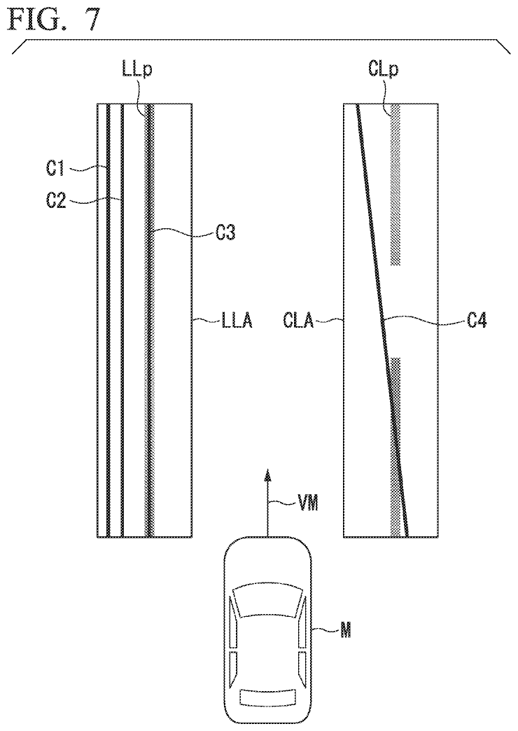

FIG. 7 is a diagram for describing recognition of the marking of the traveling lane from the marking candidates. In the example of FIG. 7, the marking candidates C1 to C4 in the marking presence areas LLA and CLA and markings LLp and CLp finally recognized in a state in which recognition accuracy acquired from the recognized marking information 192 has not been lowered are shown. In the example of FIG. 7, the markings LLp and CLp are positioned at positions within the marking presence area with respect to the position of the vehicle M so that the comparison with the marking candidates C1 to C4 within the marking presence area is facilitated.

In the example of FIG. 7, the marking recognizer 132 compares at least one of a position, a direction, and a type of the marking candidate included in the marking candidate information with the corresponding data (at least one of a position, a direction, and a type) of the marking included in the marking state information and recognizes marking for dividing the traveling lane on the basis of a comparison result. Specifically, the marking recognizer 132 performs a comparison process associated with at least one of positions, directions, and types of markings between the marking candidates C1 to C3 and the marking LLp. Degrees of similarity of the marking candidates C1 to C3 with respect to the markings LLp are extracted. For example, the marking recognizer 132 increases the degree of similarity as the position difference decreases, the direction difference decreases, and line types are similar. The marking recognizer 132 compares the marking candidate C4 with the marking CLp and similarly extracts a degree of similarity of the marking candidate C4 with respect to the marking LLp. The marking recognizer 132 extracts a marking candidate with a highest degree of similarity from the marking candidates C1 to C4 as the marking of the lane L1. In the example of FIG. 7, the positions of the marking candidates C1 and C2 are different from that of the marking LLp and the extension direction or the line type of the marking candidate C4 is different from that of the marking CLp. Therefore, the marking recognizer 132 recognizes the marking candidate C3 among the marking candidates C1 to C4 as the marking of the traveling lane (the lane L1). In these recognition processes, it is possible to prevent the marking from being erroneously recognized.

The marking recognizer 132 may not recognize the marking candidate as a marking when the degree of similarity is less than a prescribed value. The marking recognizer 132 may recognize the marking in each of the marking presence areas LLA and CLA.

The operation controller (the action plan generator 140 and the second controller 160) executes LKAS control on the basis of the marking recognized by the marking recognizer 132.

As described above, in the embodiment, even if the marking recognition accuracy is lowered, it is possible to improve the recognition accuracy or reliability of the marking by extracting an edge of an area having a high probability of presence of the marking and recognizing the marking on the basis of the extracted edge. The number of processing resources can be reduced by recognizing the markings in a limited area.

For example, when a traveling state of the vehicle M is output to the HMI 30 in a driving assistance process or the like, the HMI controller 170 may cause the display device of the HMI 30 to display an image related to the marking recognized by the marking recognizer 132. In this case, the HMI controller 170 may cause markings recognized in a state in which the recognition accuracy has been lowered and a state in which the recognition accuracy has not been lowered to be displayed in different display modes (for example, a color change mode, a blink display mode, a pattern change mode, and the like). The HMI controller 170 may cause information indicating that the marking recognition accuracy has been lowered to be output from the HMI 30. Thereby, the occupant can be notified of the state of the vehicle M more accurately.

### [Processing Flow]

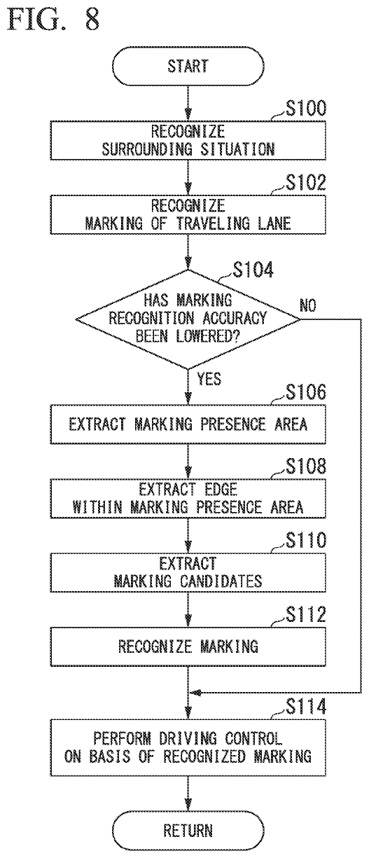

FIG. 8 is a flowchart showing an example of a flow of a process executed by the automated driving control device 100 of the embodiment. In the example of FIG. 8, a marking recognition process among processes executed by the automated driving control device 100 will be mainly described. The process of FIG. 8 may be iteratively executed, for example, while automated driving control such as LKAS is being executed.

In the example of FIG. 8, the recognizer 130 recognizes a surrounding situation of the vehicle M on the basis of a detection result of the external sensor ES (step S100). Subsequently, the marking recognizer 132 recognizes a marking of a traveling lane of the vehicle M from space information indicating the surrounding situation of the vehicle M (step S102).

Subsequently, the marking recognizer 132 determines whether or not the marking recognition accuracy has been lowered (step S104). When it is determined that the marking recognition accuracy has been lowered, the marking recognizer 132 extracts a marking presence area having a high likelihood of presence of the marking as an example of a prescribed area within the recognizable range RA of the external sensor ES (step S106). In the processing of step S106, the marking recognizer 132 may extract a marking presence area on the basis of the position of the marking, for example, before the marking recognition accuracy is lowered, or may extract a marking presence area with reference to a high-precision map (the second map information 62). The final marking presence area may be extracted on the basis of each extracted marking presence area.

Subsequently, the marking recognizer 132 captures an image of an area including the marking presence area with the camera 10 and extracts an edge within the marking presence area from the captured image (step S108). Subsequently, the marking recognizer 132 extracts marking candidates on the basis of an edge extraction result (step S110) and recognizes a marking on the basis of degrees of similarity between the extracted marking candidates and a marking recognition result acquired before the marking recognition accuracy is lowered (step S112).

When it is determined that the marking recognition accuracy has not been lowered after the processing of step S112 or in the processing of step S104, the driving controller (the action plan generator 140 and the second controller 160) executes a driving control process such as LKAS on the basis of the recognized marking (step S114). Thereby, the process of the present flowchart ends.

### Modified Example

In the above-described embodiment, the marking recognizer 132 may perform the above-described marking recognition process even if the driving control process other than LKAS is being executed. For example, when an ALC control process is performed, the marking recognizer 132 may recognize not only markings for dividing the traveling lane but also markings for dividing an adjacent lane that is a lane change destination. When a marking presence area is extracted, the marking recognizer 132 may extract a marking presence area with respect to the traveling lane on the basis of a position, a direction, or the like of the marking of the lane (the lane L2) other than the traveling lane (the lane L1) of the vehicle M, for example, as shown in FIG. 3, instead of (or in addition to) the above-described method. Further, the marking recognizer 132 may extract the marking presence area on the basis of the positions and directions of physical objects OB1 and OB2 such as guardrails installed on the road RD including the traveling lane L1.

Although an edge included in an image captured by the camera 10 is mainly extracted and a marking is recognized on the basis of an extraction result in the above-described example, an edge extraction process may be performed on the basis of a detection result (LIDAR data) of the LIDAR sensor 14 included in the external sensor ES in addition to (or instead of) the above-described edge extraction process. If there is a physical object with irregularities such as a protective barrier of a guardrail or the like, a chatter bar, a curb, or a median strip, the marking may be recognized or the marking presence area may be extracted on the basis of detection results of the radar device 12 and/or the SONAR sensor. Thereby, the marking can be recognized with higher accuracy.

The marking recognizer 132 may recognize a traveling lane by comparing a marking pattern (for example, an arrangement of solid lines and broken lines) obtained from the second map information 62 with a marking pattern near the vehicle M recognized from the image captured by the camera 10. The marking recognizer 132 may recognize the traveling lane by recognizing a traveling path boundary (a road boundary) including a marking, a road shoulder, a curb, a median strip, a guardrail, and the like as well as the marking. In this recognition, a position of the vehicle M acquired from the navigation device 50 and a processing result by the INS may be added.

When the marking recognition accuracy has been lowered and the marking recognizer 132 can recognize no marking, the HMI controller 170 may cause the HMI 30 to output information indicating that no marking can be recognized or may cause the HMI 30 to output information for prompting the occupant of the vehicle M to perform manual driving by ending the LKAS control process.

According to the above-described embodiment, the automated driving control device 100 (an example of a mobile object control device) includes the recognizer 130 configured to recognize a surrounding situation of the vehicle M (an example of a mobile object) on the basis of an output of the external sensor ES; and the marking recognizer 132 configured to recognize markings for dividing an area through which the vehicle M passes on the basis of the surrounding situation recognized by the recognizer 130, wherein the marking recognizer 132 extracts a prescribed area from the surrounding situation when it is determined that marking recognition accuracy has been lowered, extracts an edge within the extracted prescribed area, and recognizes the markings on the basis of an extraction result, whereby it is possible to further improve the accuracy of recognition of markings for dividing an area through which the vehicle M passes.

Specifically, according to the embodiment, for example, it is possible to recognize a marking with high accuracy more efficiently by extracting only a prescribed area from an image captured by the camera on the basis of the vicinity of a previous marking recognition result, the vicinity of a boundary of segmentation, and the vicinity of a position where there is a marking of high-precision map information and extracting an edge only in the extracted area. According to the embodiment, it is possible to improve the certainty of a marking by collating information of a learning-based marking recognized in a state in which the recognition accuracy has not been lowered with information of the marking recognized in the edge extraction process. According to the embodiment, it is possible to improve the accuracy or reliability of lane recognition and limit erroneous detection of markings by selecting a marking similar to a marking used in a previous control process with respect to state information of marking candidates obtained in the edge extraction process.

The embodiment described above can be represented as follows.

A mobile object control device including:

a storage device storing a program; and

a hardware processor,

wherein the hardware processor executes the program stored in the storage device to:

recognize a surrounding situation of a mobile object on the basis of an output of an external sensor;

recognize markings for dividing an area through which the mobile object passes on the basis of the recognized surrounding situation;

extract a prescribed area from the surrounding situation when it is determined that marking recognition accuracy has been lowered;

extract an edge within the extracted prescribed area; and

recognize the markings on the basis of an extraction result.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A mobile object control device comprising:
a recognizer configured to recognize a surrounding situation of a mobile object on the basis of an output of an external sensor; and
a marking recognizer configured to recognize markings for dividing an area through which the mobile object passes on the basis of the surrounding situation recognized by the recognizer,
wherein the marking recognizer extracts a prescribed area from the surrounding situation when it is determined that marking recognition accuracy has been lowered, extracts an edge within the extracted prescribed area, and recognizes the markings on the basis of an extraction result.

2. The mobile object control device according to claim 1, further comprising a storage controller configured to cause a storage to store information about the markings before the marking recognizer determines that the marking recognition accuracy has been lowered,
wherein the marking recognizer extracts marking candidates on the basis of the edge extracted from the prescribed area and recognizes the markings for dividing the area through which the mobile object passes on the basis of degrees of similarity between information about the extracted marking candidates and the information about the markings stored in the storage.

3. The mobile object control device according to claim 2, wherein the information about the markings includes at least one of positions, directions, and types of the markings.

4. The mobile object control device according to claim 2,
wherein the storage further stores map information, and
wherein the marking recognizer extracts the prescribed area on the basis of information about the markings acquired from the map information on the basis of position information of the mobile object or the information about the markings before it is determined that the marking recognition accuracy has been lowered stored in the storage when it is determined that the marking recognition accuracy has been lowered.

5. The mobile object control device according to claim 1, wherein the prescribed area is set on left and right sides in a traveling direction of the mobile object.

6. The mobile object control device according to claim 1, wherein the marking recognizer extracts the edge in the surrounding situation and determines that the marking recognition accuracy has been lowered when at least one of a length, reliability, and quality of the extracted edge is less than a threshold value.

7. A mobile object control method comprising:
recognizing, by a computer, a surrounding situation of a mobile object on the basis of an output of an external sensor;
recognizing, by the computer, markings for dividing an area through which the mobile object passes on the basis of the recognized surrounding situation;
extracting, by the computer, a prescribed area from the surrounding situation when it is determined that marking recognition accuracy has been lowered;
extracting, by the computer, an edge within the extracted prescribed area; and
recognizing, by the computer, the markings on the basis of an extraction result.

8. A computer-readable non-transitory storage medium storing a program for causing a computer to:
recognize a surrounding situation of a mobile object on the basis of an output of an external sensor;
recognize markings for dividing an area through which the mobile object passes on the basis of the recognized surrounding situation;
extract a prescribed area from the surrounding situation when it is determined that marking recognition accuracy has been lowered;
extract an edge within the extracted prescribed area; and
recognize the markings on the basis of an extraction result.
